(19) United States
(12) Patent Application Publication
(10) Pub. No.: US 2024/0029622 A1
(43) Pub. Date: Jan. 25, 2024

(54) DRIVE CIRCUIT AND DISPLAY DEVICE

(71) Applicant: TCL CHINA STAR OPTOELECTRONICS TECHNOLOGY CO., LTD., Shenzhen, Guangdong (CN)

(72) Inventor: Jhenwei HE, Shenzhen, Guangdong (CN)

(21) Appl. No.: 17/600,464

(22) PCT Filed: Sep. 1, 2021
(86) PCT No.: PCT/CN2021/116005

§ 371 Date: Sep. 30, 2021

(30) Foreign Application Priority Data
Aug. 23, 2021 (CN) 202110967192.3

(51) Int. Cl. G09G 3/20; G09G 3/36

(52) U.S. Cl. CPC G09G 3/2096; G09G 3/36; G09G 2320/103; G09G 2320/0247; G09G 2320/028; G09G 2340/0435; G09G 2310/0291

(57) ABSTRACT

A drive circuit and a display device are provided. The level conversion drive circuit includes a generation module, a control module, and a timing module. If the generation module has updated the image data and an image corresponding to the image data after the update overlaps an image corresponding to the image data before the update, the timing module stops displaying the image corresponding to the image data before the update, and displays the image corresponding to the image data after the update.

### BACKGROUND

### Technical Field

This application relates to the field of display technology, and specifically to a drive circuit and a display device.

### Related Art

The resolution of display devices is gradually increasing, and has reached up to 8K (7680×4320) at present. Provided that the size of the display panel remains unchanged, the increase in resolution leads to a decreased aperture ratio, reducing the transmittance of the display panel. Therefore, the original viewing angle improvement scheme 8-domain pixel architecture design cannot be applied to higher resolution products due to the loss of transmittance, and is therefore replaced by a 4-domain pixel architecture, which, however, results in deterioration of the viewing angle characteristics. To this end, viewing angle compensation is required for improving viewing angle characteristics.

In conventional viewing angle improvement methods, generally pixels in the effective display area of the display panel are distinguished by two states: H and L. If the pixels in the states H and L are directly separated spatially, the image will be obviously grainy, which does not meet the requirements for high image quality. Although a time-domain viewing angle improvement solution can be adopted to eliminate the grain effect, it takes at least twice the frame display time of the native display panel to maintain the H and L states to effectively improve the viewing angle due to the slow response of liquid crystals. That is, the time-domain viewing angle improvement requires displaying of at least two frames of images. However, in the variable refresh rate mode, the time-domain viewing angle improvement will produce obvious flickering.

### SUMMARY

### Technical Problem

This application provides a drive circuit and a display device, which can achieve time-domain viewing angle improvement without causing flickering.

### Technical Solution

According to a first aspect, this application provides a drive circuit, comprising:
a generation module, configured to generate image data;
a control module, configured to determine whether the generation module has updated the image data; and
a timing module, configured to display an image based on the image data, wherein
if the generation module has updated the image data and an image corresponding to the image data after the update overlaps an image corresponding to the image data before the update, the timing module stops displaying the image corresponding to the image data before the update, and displays the image corresponding to the image data after the update.

In the drive circuit provided in this application, the image data includes an image notification signal; if the control module detects the image notification signal, it is determined that the generation module has updated the image data; and if the control module does not detect the image notification signal, it is determined that the generation module has not updated the image data.

In the drive circuit provided in this application, if the generation module has updated the image data, the control module outputs the image notification signal to the timing module so that the timing module displays an image based on the image data.

In the drive circuit provided in this application, after the control module outputs the image notification signal to the timing module so that the timing module displays an image based on the image data, the control module generates a virtual image notification signal and outputs the virtual image notification signal to the timing module, so that the timing module displays an image based on the image data.

In the drive circuit provided in this application, the image displayed by the timing module based on the image data under the control of the image notification signal and the image displayed by the timing module based on the image data under the control of the virtual image notification signal are spaced by a preset time period, and the preset time period is set based on a maximum refresh rate of the display device.

In the drive circuit provided in this application, the drive circuit further includes a buffer module, and the buffer module is configured to store the image data; and

the timing module displays an image based on the image data stored in the buffer module under the control of the virtual image notification signal.

In the drive circuit provided in this application, the timing module displays, under the control of the image notification signal, an image based on the image data generated by the generation module.

In the drive circuit provided in this application, if the generation module has updated the image data and the image corresponding to the image data after the update overlaps the image corresponding to the image data before the update, the control module generates an image stop signal and outputs the image stop signal to the timing module, so that the timing module stops displaying the image corresponding to the image data before the update, and displays the image corresponding to the image data after the update.

In the drive circuit provided in this application, if the generation module has not updated the image data, the timing module displays at least two frames of images based on the image data.

According to a second aspect, this application further provides a display device, comprising a display panel and a drive circuit, wherein the display panel is electrically connected to the drive circuit; and
the drive circuit comprises:
a generation module, configured to generate image data;
a control module, configured to determine whether the generation module has updated the image data; and
a timing module, configured to display an image based on the image data, wherein
if the generation module has updated the image data and an image corresponding to the image data after the update overlaps an image corresponding to the image data before the update, the timing module stops displaying the image corresponding to the image data before the update, and displays the image corresponding to the image data after the update.

In the display device provided in this application, the image data includes an image notification signal; if the control module detects the image notification signal, it is determined that the generation module has updated the image data; and if the control module does not detect the image notification signal, it is determined that the generation module has not updated the image data.

In the display device provided in this application, if the generation module has updated the image data, the control module outputs the image notification signal to the timing module so that the timing module displays an image based on the image data.

In the display device provided in this application, after the control module outputs the image notification signal to the timing module so that the timing module displays an image based on the image data, the control module generates a virtual image notification signal and outputs the virtual image notification signal to the timing module, so that the timing module displays an image based on the image data.

In the display device provided in this application, the image displayed by the timing module based on the image data under the control of the image notification signal and the image displayed by the timing module based on the image data under the control of the virtual image notification signal are spaced by a preset time period, and the preset time period is set based on a maximum refresh rate of the display device.

In the display device provided in this application, the drive circuit further includes a buffer module, and the buffer module is configured to store the image data; and
the timing module displays an image based on the image data stored in the buffer module under the control of the virtual image notification signal.

In the display device provided in this application, the timing module displays, under the control of the image notification signal, an image based on the image data generated by the generation module.

In the display device provided in this application, if the generation module has updated the image data and the image corresponding to the image data after the update overlaps the image corresponding to the image data before the update, the control module generates an image stop signal and outputs the image stop signal to the timing module, so that the timing module stops displaying the image corresponding to the image data before the update, and displays the image corresponding to the image data after the update.

In the display device provided in this application, if the generation module has not updated the image data, the timing module displays at least two frames of images based on the image data.

Beneficial Effects

In the drive circuit and display device provided in this application, the control module is arranged between the generation module and the timing module. The control module is configured to determine whether the generation module has updated image data. If the generation module has updated the image data and an image corresponding to the image data after the update overlaps an image corresponding to the image data before the update, the timing module stops displaying the image corresponding to the image data before the update, and displays the image corresponding to the image data after the update. In other words, this application can prevent the image corresponding to the image data after the update from overlapping with the image corresponding to the image data before the update, so that time-domain viewing angle improvement can be achieved without causing flickering, thereby improving the display effect of the display device.

### BRIEF DESCRIPTION OF THE DRAWINGS

To describe the technical solutions in the embodiments of this application more clearly, the following briefly describes accompanying drawings required for describing the embodiments. Apparently, the accompanying drawings in the following description show merely some embodiments of this application, and a person skilled in the art may still derive other drawings according to these accompanying drawings without creative efforts.

FIG. 1 is a schematic structural diagram of a drive circuit according to an embodiment of this application;

FIG. 2 is a schematic diagram showing signal passing in a drive circuit according to an embodiment of this application;

FIG. 3 is another schematic structural diagram of a drive circuit according to an embodiment of this application; and

FIG. 4 is a schematic structural diagram of a display device according to an embodiment of this application.

### DETAILED DESCRIPTION

The technical solutions in the embodiments of this application are clearly and completely described below with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

It should be understood that the specific implementations described herein are merely used for describing and illustrating this application rather than limiting this application. In addition, the terms “include”, “comprise”, and any variant thereof in the claims and specification of this application are intended to cover a non-exclusive inclusion.

The embodiments of this application provide a drive circuit and a display device. It should be noted that existing viewing angle improvement methods generally adopt a time-domain viewing angle improvement solution. Although the time-domain viewing angle improvement solution can eliminate the grain effect, it takes at least twice the frame display time of the native display panel to effectively improve the viewing angle due to the slow response of liquid crystals. That is, the time-domain viewing angle improvement requires displaying of at least two frames of images. The embodiments of this application can achieve time-domain viewing angle improvement without causing flickering. A detailed description is given below. The order in which the following embodiments are described is not intended to limit the superiority of the embodiments.

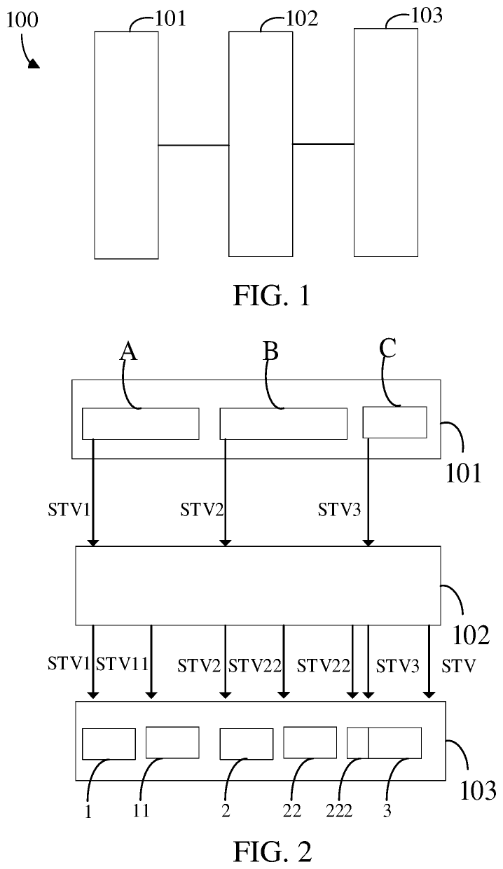

FIG. 1 is a schematic structural diagram of a drive circuit according to an embodiment of this application. As shown in FIG. 1, the drive circuit 100 provided in this embodiment of this application includes a generation module 101, a control module 102, and a timing module 103. The generation module 101 is connected to the control module 102, and the control module 102 is connected to the timing module 103.

The generation module 101 is configured to generate image data. The control module is configured to determine whether the generation module has updated the image data. The timing module 103 is configured to display an image based on the image data. If the generation module 101 has updated the image data and an image corresponding to the image data after the update overlaps an image corresponding to the image data before the update, the timing module 103 stops displaying the image corresponding to the image data before the update, and displays the image corresponding to the image data after the update. It is to be understood that by arranging the control module 102 between the generation module 101 and the timing module 103, this embodiment of this application can prevent the image corresponding to the image data after the update from overlapping with the image corresponding to the image data before the update, so that time-domain viewing angle improvement can be achieved without causing flickering.

FIG. 2 is a schematic diagram showing signal passing in a drive circuit according to an embodiment of this application. in this embodiment of this application, the image data includes an image notification signal. If the control module 102 detects the image notification signal, it is determined that the generation module 101 has updated the image data. If the control module 102 does not detect the image notification signal, it is determined that the generation module 101 has not updated the image data.

For example, as shown in FIG. 1 and FIG. 2, the generation module 101 generates first image data A, second image data B, and third image data C. The first image data A includes a first image notification signal STV1, the second image data B includes a second image notification signal STV2, and the third image data C includes a third image notification signal STV3. It should be noted that in practice, the first image data A, the second image data B, and the third image data C are generated one by one by the generation module, and are merely provided for illustrating the relationship between different image data.

In this embodiment of this application, if the generation module 101 has updated the image data, the control module 102 outputs the image notification signal to the timing module 103 so that the timing module 103 displays an image based on the image data. If the control module 102 detects an image notification signal from the generation module 101, the control module 102 determines that the generation module 101 has updated the image data. In this case, the control module 102 further outputs the image notification signal to the timing module 103, so that the timing module 103 displays an image based on the image data, thereby completing the display of one frame of image.

For example, as shown in FIG. 1 and FIG. 2, if the generation module 101 has updated the first image data A, the control module 102 outputs the first image notification signal STV1 to the timing module 103 so that the timing module 103 displays an image based on the first image data A. If the generation module 101 has updated the second image data B, the control module 102 outputs the second image notification signal STV2 to the timing module 103 so that the timing module 103 displays an image based on the second image data B. If the generation module 101 has updated the third image data C, the control module 102 outputs the third image notification signal STV3 to the timing module 103 so that the timing module 103 displays an image based on the third image data C.

In this embodiment of this application, after the control module 102 outputs the image notification signal to the timing module 103 so that the timing module 103 displays an image based on the image data, the control module 102 generates a virtual image notification signal and outputs the virtual image notification signal to the timing module 103, so that the timing module 103 displays an image based on the image data. That is, the control module 102 outputs the image notification signal to the timing module 103, and the timing module 103 displays an image based on the image data, thus completing the display of one frame of image. After completing the display of one frame of image, the timing module 103 continues to display a next frame of image based on the same image data. It should be noted that after the display of one frame of image is completed, the display of multiple frames of images may be performed based on the same image data as needed.

If the generation module 101 has not updated the image data, the timing module 103 displays at least two frames of images based on the image data.

For example, as shown in FIG. 1 and FIG. 2, after the control module 102 outputs the first image notification signal STV1 to the timing module 103 so that the timing module 103 displays an image based on the first image data A, the control module 102 generates a first virtual image notification signal STV11 and outputs the first virtual image notification signal STV11 to the timing module 103, so that the timing module 103 displays an image based on the first image data A. In this case, the timing module 103 displays two frames of images based on the first image data A, where the display of a first frame of image 1 is completed under the control of the first image notification signal STV1, and the display of a second frame of image 11 is completed under the control of the first virtual image notification signal STV11. After the control module 102 outputs the second image notification signal STV2 to the timing module 103 so that the timing module 103 displays an image based on the second image data B, the control module 102 generates a second virtual image notification signal STV22 and outputs the second virtual image notification signal STV22 to the timing module 103, so that the timing module 103 displays an image based on the second image data B. In this case, the timing module 103 displays three frames of images based on the second image data B, where the display of a first frame of image 2 is completed under the control of the second image notification signal STV2, the display of a second frame of image 22 is completed under the control of one second virtual image notification signal STV22, and the display of a third frame of image 222 is completed under the control of another second virtual image notification signal STV22. The timing module 103 displays an image based on the third image data C, where completes the display of a first frame of image 3 is completed under the control of a third image notification signal STV3.

In this embodiment of this application, the image displayed by the timing module 103 based on the image data under the control of the image notification signal and the image displayed by the timing module 103 based on the image data under the control of the virtual image notification signal are spaced by a preset time period. The preset time period is set based on a maximum refresh rate of the display device. The preset time may be set as the maximum refresh rate of the display device. Further, an interval between images displayed based on the same image data may also be set to the preset time period.

For example, as shown in FIG. 1 and FIG. 2, the image displayed by the timing module 103 based on the first image data A under the control of the first image notification signal STV1 and the image displayed by the timing module 103 based on the first image data A under the control of the first virtual image notification signal STV11 are spaced by the preset time period. The image displayed by the timing module 103 based on the second image data B under the control of the second image notification signal STV2 and the image displayed by the timing module 103 based on the second image data B under the control of the second virtual image notification signal STV22 are spaced by the preset time period. An interval between images displayed based on the first image data A may also be set to the preset time period. An interval between images displayed based on the second image data B may also be set to the preset time period.

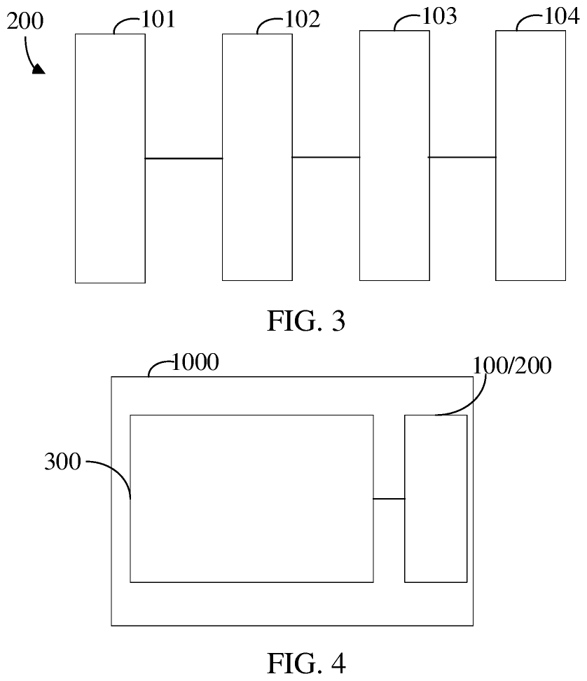

FIG. 3 is another schematic structural diagram of a drive circuit according to an embodiment of this application. The difference between the drive circuit 200 shown in FIG. 3 and the drive circuit 100 shown in FIG. 1 lies in that: the drive circuit 200 shown in FIG. 3 further includes a buffer module 104, and the buffer module 104 is configured to store the image data. The timing module 103 displays an image based on the image data stored in the buffer module 104 under the control of the virtual image notification signal. The timing module displays 103, under the control of the image notification signal, an image based on the image data generated by the generation module 101.

For example, as shown in FIG. 2 and FIG. 3, the control module 102 outputs the first image notification signal STV1 to the timing module 103 so that the timing module 103 displays an image based on the first image data A generated by the generation module. The control module 102 outputs the first virtual image notification signal STV11 to the timing module 103 so that the timing module 103 displays an image based on the first image data A stored in the buffer module. The control module 102 outputs the second image notification signal STV2 to the timing module 103 so that the timing module 103 displays an image based on the second image data B generated by the generation module 101. The control module 102 outputs the second virtual image notification signal STV22 to the timing module 103 so that the timing module 103 displays an image based on the second image data B stored in the buffer module 104.

In this embodiment of this application, if the generation module 101 has updated the image data and the image corresponding to the image data after the update overlaps the image corresponding to the image data before the update, the control module 102 generates an image stop signal STV and outputs the image stop signal STV to the timing module 103, so that the timing module 103 stops displaying the image corresponding to the image data before the update, and displays the image corresponding to the image data after the update.

For example, as shown in FIG. 1 and FIG. 2, after the control module 102 outputs the second image notification signal STV2 to the timing module 103 so that the timing module 103 displays an image based on the second image data B, the control module 102 generates a second virtual image notification signal STV22 and outputs the second virtual image notification signal STV22 to the timing module 103, so that the timing module 103 displays an image based on the second image data B. In this case, the timing module 103 displays three frames of images based on the second image data B, where the display of a first frame of image is completed under the control of the second image notification signal STV2, the display of a second frame of image is completed under the control of one second virtual image notification signal STV22, and the display of a third frame of image is completed under the control of another second virtual image notification signal STV22. In addition, while the display of the third frame of image is completed under the control of the another second virtual image notification signal STV22, the generation module 101 generates the third image data C, and the image corresponding to the third image data C overlaps the third frame of image to be completed under the control of the another second virtual image notification signal STV22. In this case, the control module 102 generates the image stop signal STV and outputs the image stop signal STV to the timing module 103, so that the timing module 103 stops displaying the third frame of image to be completed under the control of the another second virtual image notification signal STV22, and displays the image corresponding to the third image data C.

In the drive circuit provided in the embodiments of this application, the control module is arranged between the generation module and the timing module. The control module is configured to determine whether the generation module has updated image data. If the generation module has updated the image data and an image corresponding to the image data after the update overlaps an image corresponding to the image data before the update, the timing module stops displaying the image corresponding to the image data before the update, and displays the image corresponding to the image data after the update. In other words, this application can prevent the image corresponding to the image data after the update from overlapping with the image corresponding to the image data before the update, so that time-domain viewing angle improvement can be achieved without causing flickering.

FIG. 4 is a schematic structural diagram of a display device according to an embodiment of this application. As shown in FIG. 3, the display device 1000 provided in this embodiment of this application includes a display panel 300 and the above-mentioned drive circuit 100/200, and the display panel 300 is electrically connected to the drive circuit 100/200.

In the display device provided in the embodiments of this application, the control module is arranged between the generation module and the timing module. The control module is configured to determine whether the generation module has updated image data. If the generation module has updated the image data and an image corresponding to the image data after the update overlaps an image corresponding to the image data before the update, the timing module stops displaying the image corresponding to the image data before the update, and displays the image corresponding to the image data after the update. In other words, this application can prevent the image corresponding to the image data after the update from overlapping with the image corresponding to the image data before the update, so that time-domain viewing angle improvement can be achieved without causing flickering, thereby improving the display effect of the display device.

The drive circuit and the display device provided in the embodiments of this application are described in detail above. The principles and implementations of this application are described through specific examples in this specification, and the descriptions of the embodiments are only intended to help understand the methods and core ideas of this application. Meanwhile, a person of ordinary skill in the art may make modifications to the specific implementations and application scopes according to the ideas of this application. In conclusion, the content of the specification should not be construed as a limitation to this application.

What is claimed is:

1. A drive circuit, comprising:
a generation module configured to generate image data;
a control module configured to determine whether the generation module has updated the image data; and
a timing module configured to display an image based on the image data, wherein
if the generation module has updated the image data and an image corresponding to the image data after the update overlaps an image corresponding to the image data before the update, the timing module stops displaying the image corresponding to the image data before the update, and displays the image corresponding to the image data after the update.

2. The drive circuit according to claim 1, wherein the image data comprises an image notification signal; if the control module detects the image notification signal, it is determined that the generation module has updated the image data; and if the control module does not detect the image notification signal, it is determined that the generation module has not updated the image data.

3. The drive circuit according to claim 2, wherein if the generation module has updated the image data, the control module outputs the image notification signal to the timing module so that the timing module displays an image based on the image data.

4. The drive circuit according to claim 3, wherein after the control module outputs the image notification signal to the timing module, so that the timing module displays an image based on the image data, the control module generates a virtual image notification signal and outputs the virtual image notification signal to the timing module, so that the timing module displays an image based on the image data.

5. The drive circuit according to claim 4, wherein the image displayed by the timing module based on the image data under the control of the image notification signal and the image displayed by the timing module based on the image data under the control of the virtual image notification signal are spaced by a preset time period, and the preset time period is set based on a maximum refresh rate of the display device.

6. The drive circuit according to claim 4, wherein the drive circuit further comprises a buffer module, and the buffer module is configured to store the image data; and
the timing module displays an image based on the image data stored in the buffer module under the control of the virtual image notification signal.

7. The drive circuit according to claim 6, wherein the timing module displays, under the control of the image notification signal, an image based on the image data generated by the generation module.

8. The drive circuit according to claim 1, wherein if the generation module has updated the image data and the image corresponding to the image data after the update overlaps the image corresponding to the image data before the update, the control module generates an image stop signal and outputs the image stop signal to the timing module, so that the timing module stops displaying the image corresponding to the image data before the update, and displays the image corresponding to the image data after the update.

9. The drive circuit according to claim 1, wherein if the generation module has not updated the image data, the timing module displays at least two frames of images based on the image data.

10. A display device, comprising a display panel and a drive circuit, wherein the display panel is electrically connected to the drive circuit; and
the drive circuit comprises:
a generation module configured to generate image data;
a control module configured to determine whether the generation module has updated the image data; and
a timing module configured to display an image based on the image data, wherein
if the generation module has updated the image data and an image corresponding to the image data after the update overlaps an image corresponding to the image data before the update, the timing module stops displaying the image corresponding to the image data before the update, and displays the image corresponding to the image data after the update.

11. The display device according to claim 10, wherein the image data comprises an image notification signal; if the control module detects the image notification signal, it is determined that the generation module has updated the image data; and if the control module does not detect the image notification signal, it is determined that the generation module has not updated the image data.

12. The display device according to claim 11, wherein if the generation module has updated the image data, the control module outputs the image notification signal to the timing module so that the timing module displays an image based on the image data.

13. The display device according to claim 12, wherein after the control module outputs the image notification signal to the timing module, so that the timing module displays an image based on the image data, the control module generates a virtual image notification signal and outputs the virtual image notification signal to the timing module, so that the timing module displays an image based on the image data.

14. The display device according to claim 13, wherein the image displayed by the timing module based on the image data under the control of the image notification signal and the image displayed by the timing module based on the image data under the control of the virtual image notification signal are spaced by a preset time period, and the preset time period is set based on a maximum refresh rate of the display device.

15. The display device according to claim 13, wherein the drive circuit further comprises a buffer module, and the buffer module is configured to store the image data; and
the timing module displays an image based on the image data stored in the buffer module under the control of the virtual image notification signal.

16. The display device according to claim 15, wherein the timing module displays, under the control of the image notification signal, an image based on the image data generated by the generation module.

17. The display device according to claim 10, wherein if the generation module has updated the image data and the image corresponding to the image data after the update overlaps the image corresponding to the image data before the update, the control module generates an image stop signal and outputs the image stop signal to the timing module, so that the timing module stops displaying the image corresponding to the image data before the update, and displays the image corresponding to the image data after the update.

18. The display device according to claim 10, wherein if the generation module has not updated the image data, the timing module displays at least two frames of images based on the image data.
